(19) United States
(12) Patent Application Publication
(10) Pub. No.: US 2019/0020786 A1
(43) Pub. Date: Jan. 17, 2019

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Daiki Tachi, Tokyo (JP)

(21) Appl. No.: 16/023,191

(22) Filed: Jun. 29, 2018

(30) Foreign Application Priority Data
Jul. 11, 2017 (JP) 2017-135659

(51) Int. Cl. H04N 1/44; H04N 1/32; H04N 1/00; G06F 21/60

(52) U.S. Cl. CPC H04N 1/4486; H04N 1/32272; G06F 21/602; H04N 1/32475; H04N 1/00281

(57) ABSTRACT

The image processing apparatus capable of executing a transmission job for transmitting image data to a destination that accepts a setting for notifying an end of the transmission job, converts image data to image data of a first format without encrypting, and executes a first transmission job for transmitting the image data of the first format. In accordance with the setting, the image data of the first format and an end of the first transmission job are notified to a predetermined destination. In addition, the image data is encrypted to convert it to image data of a second format, and a second transmission job for transmitting the image data of the second format is executed. In accordance with the setting, an end of the second transmission job is notified to the predetermined destination.

### BACKGROUND OF THE INVENTION

### Field of the Invention

The present invention relates to an image processing apparatus, a method of controlling the same, and a storage medium.

### Description of the Related Art

As prior methods for transmitting image data, for example, fax, ifax (Internet fax), electronic mail, and also file transmission are known. File transmission means transmitting image data by a transmission protocol such as SMB (Server Message Block) or FTP (File Transfer Protocol), for example.

Japanese Patent Laid-Open No. 2013-243541 discloses, in an image processing apparatus, when a transmission job, a copy job, or the like of image data has ended, notifying a result thereof as a “job end notification” by an email to a destination that is designated in advance. Consequently, when a large amount of time is required for execution of a transmission job for example, a user can confirm the end of the job in accordance with this notification. In addition, it is recited that the “job end notification” can be used for history management of the job, and that it is possible to, as a part of history management of a job, attach a transmitted original to an electronic mail for the “job end notification”.

There is a function for encrypting and transmitting image data to be sent for confidentiality preservation in a transmission function for image data in an image processing apparatus or the like. Image data encrypted and transmitted in this way can be viewed by a person who knows the password for the image data. However, attaching image data, which was encrypted and transmitted, to a “job end notification” and mistakenly transmitting this notification to a person whose viewing of confidential information is not desired can be considered. In such a case, there is a risk that this will lead to leakage of the confidential information.

### SUMMARY OF THE INVENTION

An aspect of the present invention is to eliminate the above-mentioned problem with conventional technology.

A feature of the present invention is to provide a technique for preventing leakage of confidential information by configuring such that image data that is encrypted and transmitted is not attached to a job end notification.

According to a first aspect of the present invention, there is provided an image processing apparatus capable of executing a transmission job for transmitting image data to a transmission destination, the apparatus comprising: a scanner that reads a document and generates image data; a memory storing instructions; and at least one processor that executes the instructions to cause the image processing apparatus to: accept a setting for notifying an end of the transmission job; convert the image data generated by the scanner to image data of a first format without encrypting; execute a first transmission job for transmitting the image data of the first format; make a notification, in accordance with the setting, of the image data of the first format and an end of the first transmission job to a predetermined transmission destination; convert the image data generated by the scanner to image data of a second format by encrypting; execute a second transmission job for transmitting the image data of the second format; and make a notification, in accordance with the setting, of an end of the second transmission job to the predetermined transmission destination, wherein the image data of the second format is not included in the notification of the end of the second transmission job.

According to a second aspect of the present invention, there is provided a method of controlling an image processing apparatus capable of executing a transmission job for transmitting image data to a transmission destination, the method comprising: accepting a setting for notifying an end of the transmission job; converting the image data generated by a scanner of the image processing apparatus to image data of a first format without encrypting; executing a first transmission job for transmitting the image data of the first format; making a notification, in accordance with the setting, of the image data of the first format and an end of the first transmission job to a predetermined transmission destination; converting the image data generated by the scanner to image data of a second format by encrypting; executing a second transmission job for transmitting the image data of the second format; and making a notification, in accordance with the setting, of an end of the second transmission job to the predetermined transmission destination, wherein the notification of the end of the second transmission job does not include the image data of the second format.

According to a third aspect of the present invention, there is provided a computer readable storage medium on which is stored a computer program for making a computer execute a control method for an image processing apparatus capable of executing a transmission job for transmitting image data to a transmission destination, the method comprising: accepting a setting for notifying an end of the transmission job; converting the image data generated by a scanner of the image processing apparatus to image data of a first format without encrypting; executing a first transmission job for transmitting the image data of the first format; making a notification, in accordance with the setting, of the image data of the first format and an end of the first transmission job to a predetermined transmission destination; converting the image data generated by the scanner to image data of a second format by encrypting; executing a second transmission job for transmitting the image data of the second format; and making a notification, in accordance with the setting, of an end of the second transmission job to the predetermined transmission destination, wherein the notification of the end of the second transmission job does not include the image data of the second format.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view for describing an overall configuration of an image processing system according to a first embodiment.

FIG. 2 is a block diagram for describing a hardware configuration of an MFP according to the first embodiment.

FIG. 3 is a block diagram for describing a hardware configuration of a file server according to the first embodiment.

FIG. 4 is a block diagram for describing a hardware configuration of a PC according to the first embodiment.

FIGS. 5A and 5B depict views illustrating examples of screens displayed on a display unit of a console unit of the MFP according to the first embodiment.

FIG. 6 depicts a view illustrating an example of a screen for newly registering a transmission destination for image data displayed on the display unit of the console unit of the MFP according to the first embodiment.

FIG. 7 depicts a view illustrating an example of a screen for registering in an address book a destination for file transmission that is displayed on the display unit of the console unit of the MFP according to the first embodiment.

FIG. 8 depicts a view illustrating an example of a destination management table that is stored in an HDD of the MFP according to the first embodiment.

FIGS. 9A and 9B are flowcharts for describing processing for transmitting a job end notification after the MFP according to the first embodiment transmits image data.

FIG. 10 depicts a view illustrating an example of a screen for selecting a file format of image data to transmit that is displayed on the display unit of the console unit of the MFP according to the first embodiment.

FIG. 11 depicts a view illustrating an example of a screen, displayed on the display unit of the console unit of the MFP according to the first embodiment, for when encryption is instructed in accordance with a button 1006.

FIG. 12 is a flowchart for describing processing for when the MFP according to a second embodiment displays a setting screen for a job end notification.

FIG. 13 is a flowchart for describing processing for when the MFP according to the second embodiment displays a setting screen for a file format.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

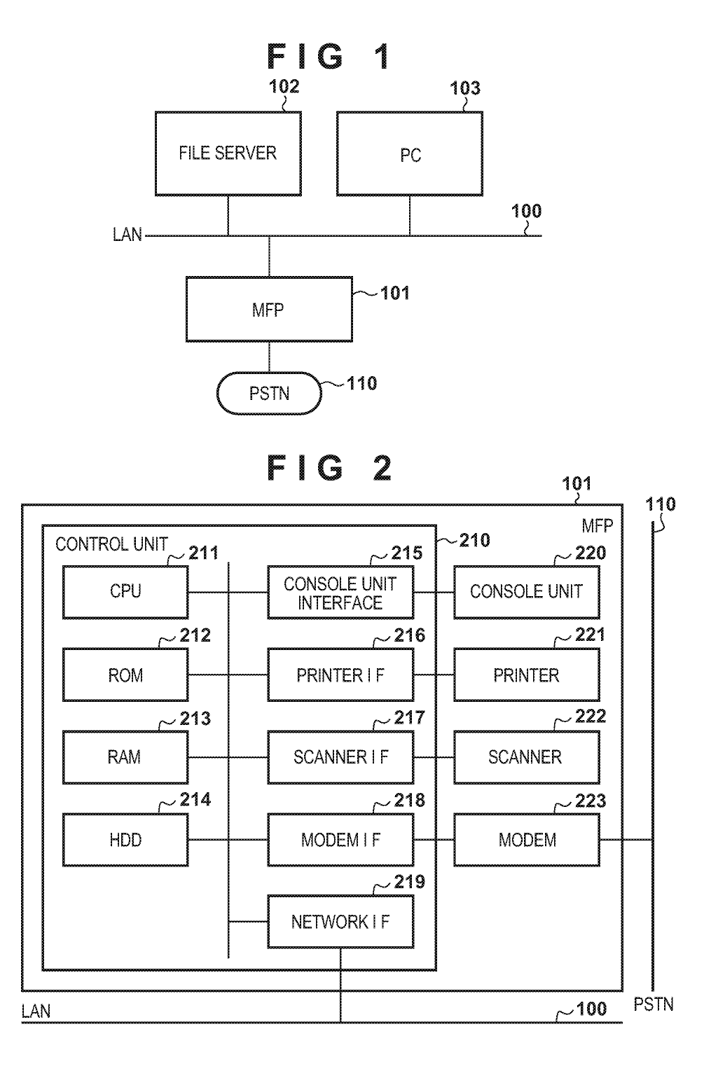

FIG. 1 depicts a view for describing an overall configuration of an image processing system according to a first embodiment.

In a LAN (Local Area Network) 100, an MFP (Multifunction Peripheral) 101, a file server 102, and a PC (Personal Computer) 103 are communicably connected to one another. The MFP 101 is an example of an image processing apparatus according to the present invention, and although example is given of a multifunction peripheral (MFP) here, the present invention is not limited to this and may be, for example, a PC, a facsimile apparatus, a communication apparatus, an information terminal, or the like. The file server 102 is an example of a file management apparatus. The PC 103 is an example of an information processing apparatus.

The MFP 101 can use SMB or FTP to perform file transmission of image data, taking a folder of the PC 103 of the file server 102 as a destination. In addition, the MFP 101 can transmit the image data by an email via a mail server that is not shown graphically. In addition, the MFP 101 can perform transmission/reception of a fax with a fax machine that is not shown graphically and is connected via a PSTN (public switched telephone network) 110. Note that an image processing system is assumed to include the MFP 101, the file server 102, and the PC 103, but it is possible to refer to only the MFP 101 as an image processing system.

FIG. 2 is a block diagram describing a hardware configuration of the MFP 101 according to the first embodiment.

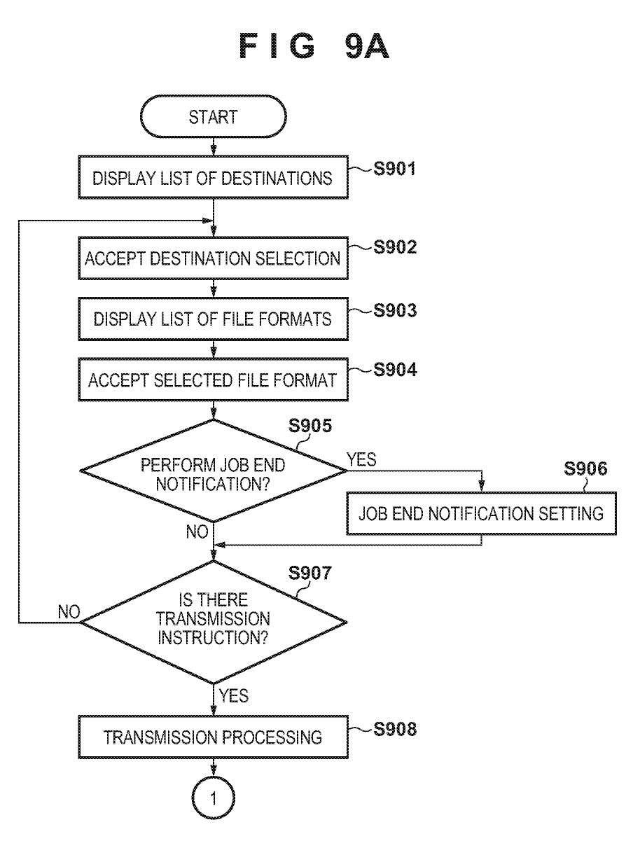

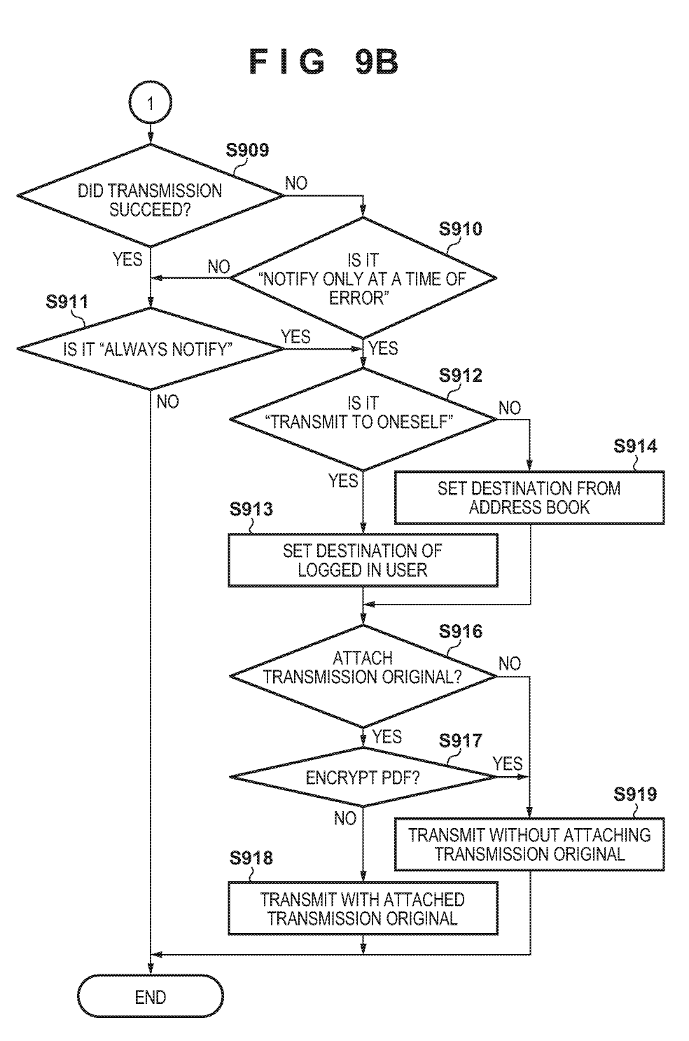

A control unit 210, which includes a CPU 211, controls operations of the MFP 101 overall. The CPU 211 executes the boot program recorded in a ROM 212 to deploy a control program stored in an HDD 214 to a RAM 213, and executes this deployed program to perform various operations such as reading control or transmission control. The RAM 213 is used as a temporary storage area such as a main memory or a work area of the CPU 211. Note that it is assumed that the MFP 101 executes various processing illustrated in the flowcharts of FIGS. 9, 12 and 13 which are described later by a single CPU 211 using one memory (the RAM 213 or the HDD 214), but another configuration may be taken. For example, it is possible to execute various processes illustrated by the flowcharts of FIGS. 9A and 9B, FIG. 12 and FIG. 13 by causing a plurality of CPUs or a plurality of RAMs or HDDs to cooperate.

The HDD 214 stores image data and various programs. A console unit interface 215 is connected to a console unit 220 and the control unit 210. The console unit 220 is provided with a keyboard, a display unit having touch panel function, or the like. A printer I/F 216 connects a printer 221 and the control unit 210. Image data to be printed by the printer 221 is transferred from the control unit 210 via the printer I/F 216 to the printer 221, and is printed to a recording material (a sheet) by the printer 221. A scanner I/F 217 connects a scanner 222 and the control unit 210. The scanner 222 generates image data by reading an image of an original, and supplies the image data to the control unit 210 via the scanner I/F 217. The MFP 101 can transmit image data generated by the scanner 222 by attaching it to an electronic mail or a file transmission. A modem I/F 218 connects a modem 223 and the control unit 210. The modem 223 connects the control unit 210 (the MFP 101) to the PSTN 110. The modem 223 executes transmission/reception of a fax with a fax machine on the PSTN 110. A network I/F 219 connects the control unit 210 (the MFP 101) to a LAN 100. The network I/F 219 transmits information of image data to an external apparatus (the PC 103, the file server 102, or the like) on the LAN 100, and receives various pieces of information from an external apparatus on the LAN 100.

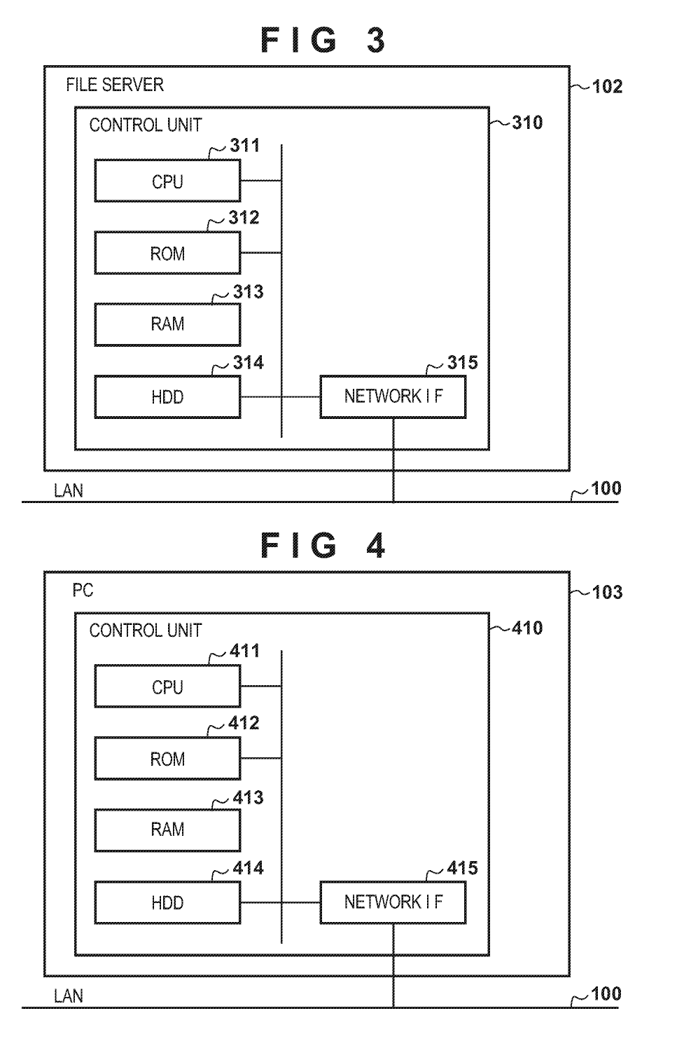

FIG. 3 is a block diagram for describing a hardware configuration of the file server 102 according to the first embodiment.

A control unit 310 which includes a CPU 311 controls overall operation of the file server 102. The CPU 311 executes the boot program recorded in a ROM 312 to deploy a program stored in an HDD 314 to a RAM 313, and executes this deployed program to perform control processing. The RAM 313 is used as a temporary storage area such as a main memory or a work area of the CPU 311. The HDD 314 stores image data and various programs. A network I/F 315 connects the control unit 310 (the file server 102) to the LAN 100. The network I/F 315 transmits and receives various pieces of information with other apparatuses on the LAN 100.

FIG. 4 is a block diagram for describing a hardware configuration of the PC 103 according to the first embodiment.

A control unit 410, which includes a CPU 411, controls overall operation of the PC 103. The CPU 411 executes the boot program recorded in a ROM 412 to deploy a program stored in an HDD 414 to a RAM 413, and executes this deployed program to perform control processing. The RAM 413 is used as a temporary storage area such as a main memory or a work area of the CPU 411. The HDD 414 stores image data and various programs. A network I/F 415 connects the control unit 410 (the PC 103) to the LAN 100. The network I/F 415 transmits and receives various pieces of information with other apparatuses on the LAN 100.

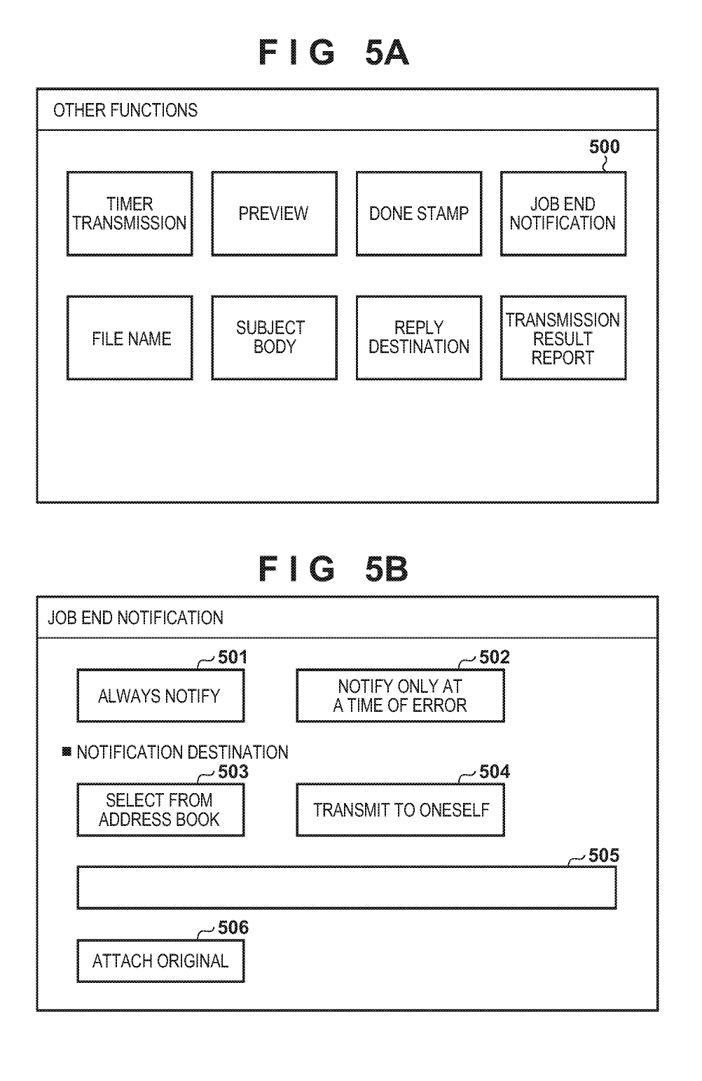

FIGS. 5A and 5B depict views illustrating examples of screens displayed on a display unit of the console unit 220 of the MFP 101 according to the first embodiment, and FIG. 5A depicts a view illustrating an example of a setting screen for other functions after transitioning from a menu screen. FIG. 5B depicts a view illustrating an example of a screen for setting a transmission destination of a job end notification, the screen displayed when a “job end notification” button 500 is selected on the screen of FIG. 5A. The screen illustrated by FIG. 5A is displayed when setting a job end notification for notifying a result of an image transmission by an email.

In FIG. 5A, the “job end notification” button 500 is a button for instructing so as to perform a setting for transmitting a job end notification to a desired destination when a transmission job for transmitting image data ends.

In FIG. 5B, buttons 501 and 502 are buttons for setting transmission conditions of the job end notification. When “always notify” is selected by a user pressing the button 501, a job end notification is always executed when an image transmission completes. In addition, when “notify only at a time of error” is selected by a user pressing the button 502, a job end notification is executed only in a case where an image transmission has an error termination. In a case where “notify only at a time of error” is selected by the button 502, when an image transmission completes, a transmission result thereof is confirmed, and a job end notification is transmitted by an email only in a case where the transmission result is in error. In contrast, when the image transmission has a successful termination, transmission of an email for a job end notification is not performed.

Buttons 503 and 504 are buttons for selecting a notification destination of a job end notification. When “select from address book” is selected by a user pressing the button 503, an address book screen is displayed, and the user is caused to select a destination to which to transmit a job end notification. In addition, when “transmit to oneself” is selected by a user pressing the button 504, an electronic mail address for the user which is registered in login information of the user who is performing operations is set as the destination of a job end notification. Consequently effort for the user to select their own destination from an address book is unnecessary.

The login information is associated with a user ID and a password, and also an electronic mail address of the user, and is registered in the HDD 214. The MFP 101 accepts input of the user ID and the password from the user, and permits login of the user. By this, the MFP 101 can obtain the electronic mail address of the logged-in user by referring to the login information. Note that, in a case of authenticating a user by using an authentication server, configuration may be taken such that the MFP 101 transmits the accepted user ID and password to the authentication server, and receives from the authentication server login information that is registered in advance in the authentication server. In such a case, the MFP 101 can obtain the electronic mail address of the logged-in user by referring to the received login information. Note that configuration may be taken so that, in a case of the MFP 101 authenticating, by a card reader, a user by reading information stored in a card that the user holds, the information read from the card is used as the user ID, and a password is not used. In such a case, the MFP 101 authenticates the user by comparing the user ID with a user ID stored in the HDD 214 in advance.

The set notification destination for a job end notification selected in accordance with the button 503 or the button 504 is displayed in a column 505. A button 506 is a button for letting a user select whether or not to transmit by attaching image data of an original transmitted by an image transmission to a job end notification. When a user selects “attach original” by pressing the button 506, it is possible to cause image data that is transmitted by an image transmission to be attached to an electronic mail for a job end notification and transmitted.

In the first embodiment, when image data is attached, attachment is performed after it is converted to a PDF (Portable Document Format) file, but attachment may be performed after conversion to a file format other than PDF.

In this way, by performing a setting for a job end notification, it is possible to make a setting so as to notify a result of an image transmission to a desired destination in accordance with a condition that is set. Consequently, a user can confirm the result of an image transmission, for example by email.

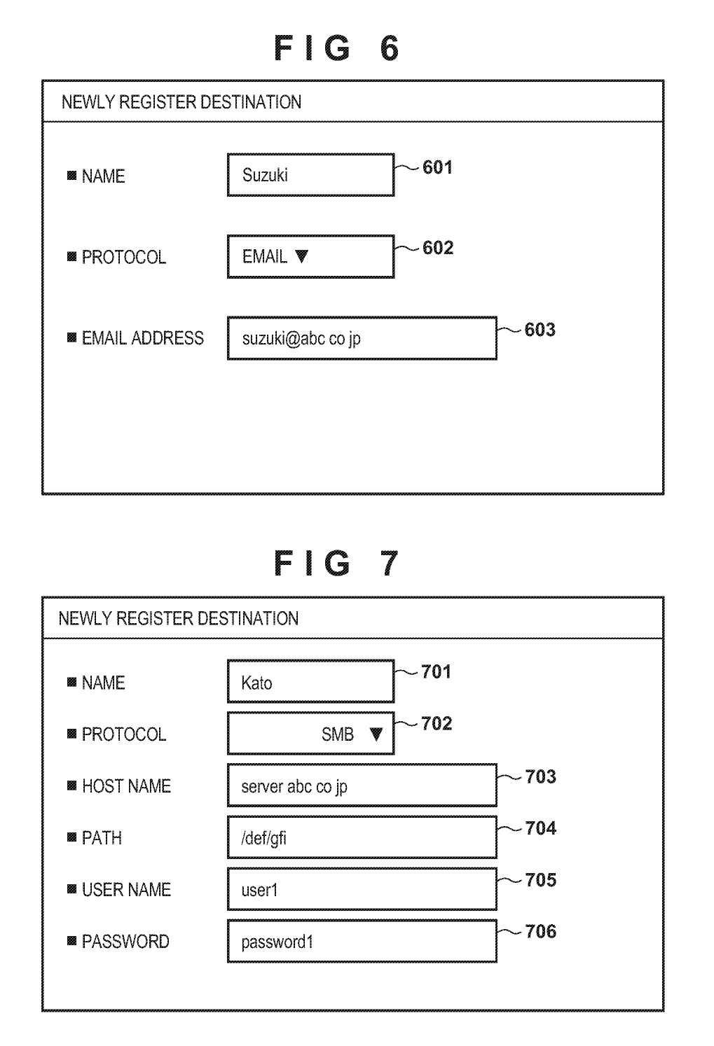

FIG. 6 depicts a view illustrating an example of a screen for newly registering a transmission destination for image data displayed on the display unit of the console unit 220 of the MFP 101 according to the first embodiment.

This screen is displayed upon registration of a destination for transmitting image data, by using electronic mail, in an address book. A column 601 is an area for inputting a name of a destination that a user registers. A button 602 is for selecting a protocol to use in transmission of image data. With the MFP 101, it is possible to select one of electronic mail, SMB, and FTP as a transmission protocol. However, a transmission protocol other than these (for example, WebDAV (Distributed Authoring and Versioning protocol for the WWW)) may be included as an option.

Protocol options are displayed in a drop-down format when a user presses the button 602, and the user can select a desired transmission protocol from the displayed options. Registration for SMB and FTP is described with reference to FIG. 7. A column 603 is an area for a user to input an electronic mail address that is to be a destination of image data.

In the example of FIG. 6, the name of the destination is “Suzuki”, the protocol to transmit by is “email”, and the address for the destination of the electronic mail is “suzuki@abc.co.jp”.

FIG. 7 depicts a view illustrating an example of a screen, which is displayed on the display unit of the console unit 220 of the MFP 101 according to the first embodiment, for registering in an address book a destination for file transmission.

This screen is displayed upon registration of a destination for a file transmission in an address book. A column 701 is an area for inputting a name of a destination to register. A button 702 is for selecting a transmission protocol to use in transmission of image data. Similarly to the button 602 of FIG. 6, a user can select a desired transmission protocol from options that are displayed in a drop-down format upon pressing the button 702. In FIG. 7, SMB is selected as the transmission protocol. Columns 703 and 704 are areas for inputting information (a host name and a path) for specifying a folder to be a destination of image data. Columns 705 and 706 are areas for inputting authentication information (a user name and a password) necessary for accessing the folder specified by the columns 703 and 704.

In the example of FIG. 7, the name of the destination is “Kato”, the protocol for transmission is the SMB, the host computer name of the destination is “server.abc.co.jp”, and the path of the folder for image data to transmit is “/def/gfi”. Furthermore, the user name and the password are respectively “user1” and “password1”.

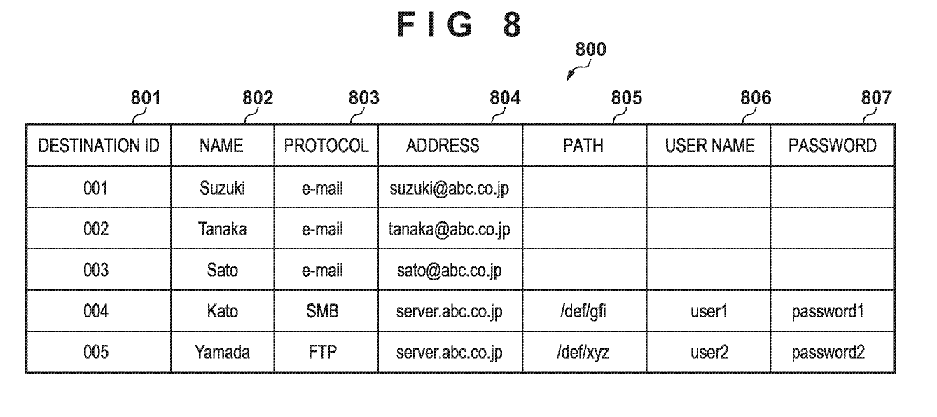

FIG. 8 depicts a view illustrating an example of a destination management table 800 that is stored in the HDD 214 of the MFP 101 according to the first embodiment.

The destination information inputted via the screens of FIG. 6 or FIG. 7 which are previously described is managed by being registered in the destination management table 800. A destination ID 801 uniquely specifies a destination that is managed by the destination management table 800. A name 802 and a protocol 803 correspond to the name and protocol decided in accordance with the column 601 and the button 602 or the column 701 and the button 702, respectively, which are described with reference to FIG. 6 or FIG. 7. An address 804, a path 805, a user name 806, and a password 807 respectively correspond to the host name, path, user name, and password of the columns 703 through 706 described with reference to FIG. 7.

FIGS. 9A and 9B are flowcharts for describing processing for transmitting a job end notification after the MFP 101 according to the first embodiment transmits image data. Note that the processing illustrated in this flowchart is achieved by the CPU 211 executing a program that has been deployed to the RAM 213.

Firstly, in step S901, the CPU 211 displays on the console unit 220 a list of destinations for transmitting image data, in accordance with an instruction from a user. Here, for example “Suzuki”, “Tanaka”, “Sato”, “Kato”, and “Yamada” are displayed on the destination list screen in the case that details of an address book are the destination management table 800 illustrated in FIG. 8. Next, the processing advances to step S902, and the CPU 211 accepts a destination selected by a user from the displayed list of destinations via the console unit 220. Next, the processing proceeds to step S903, and the CPU 211 displays a list screen for file formats of image data to transmit.

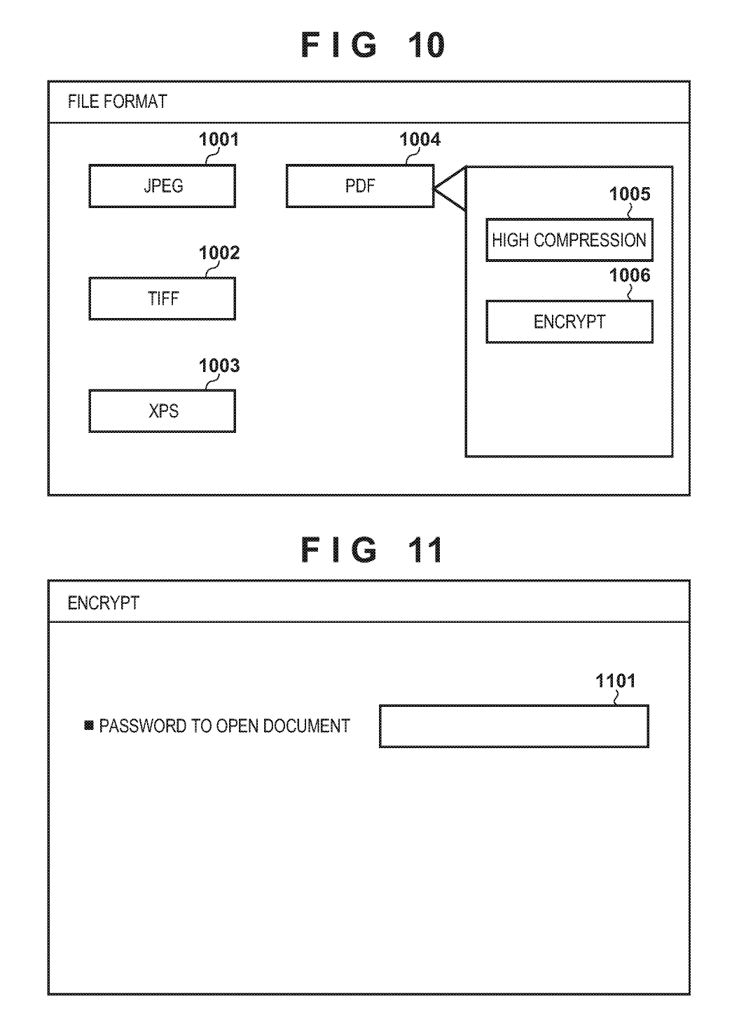

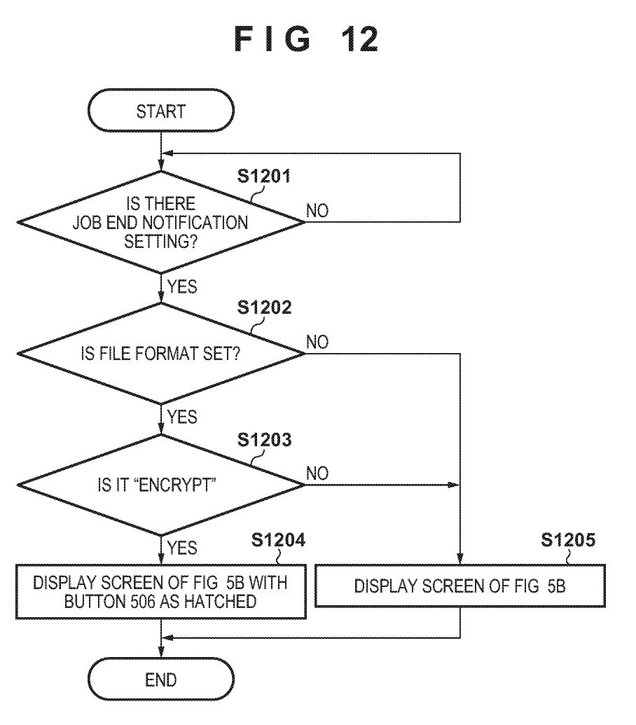

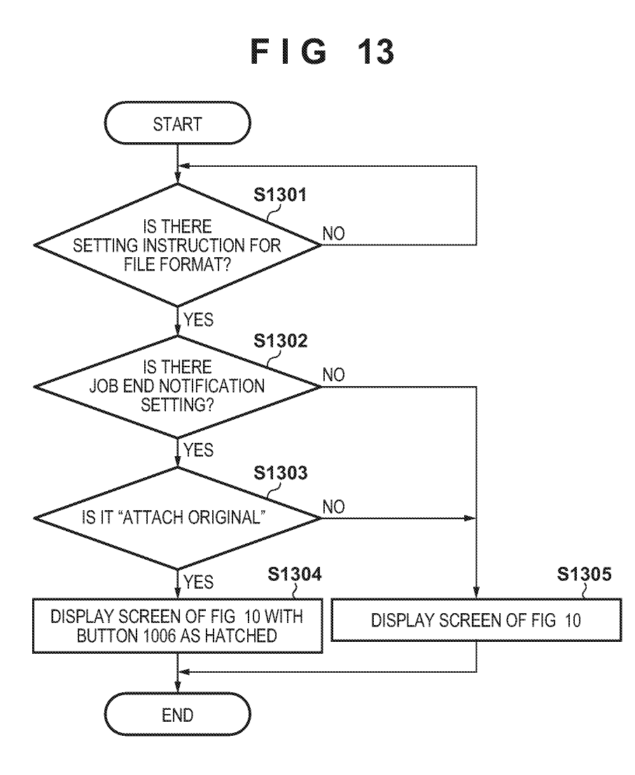

FIG. 10 depicts a view illustrating an example of a screen for selecting a file format of image data to transmit that is displayed on the display unit of the console unit 220 of the MFP 101 according to the first embodiment. This screen is displayed at a time of selecting a transmission format for transmission of image data.

Buttons 1001 through 1004 are for selecting a format of image data to transmit, and a user can, by pressing one of these buttons, designate a format corresponding to the button. Here, when a user presses the button 1001, “JPEG” is selected as the format. In this case, file transmission is performed after converting the image data of an original obtained by the scanner 222 to a JPEG (Joint Photographic Experts Group) file. Here, when a user operates the button 1002, “TIFF” is selected as the file format. In this case, file transmission is performed after converting the image data of an original obtained by the scanner 222 to a TIFF (Tagged Image File Format) file. Similarly when the button 1003 or the button 1004 is pressed, file transmission is performed after converting the image data for the original to an XPS (XML Paper Specification) file or a PDF file, respectively. The buttons 1005 and 1006 are for selecting additional information for the button 1004 (PDF), with the button 1005 instructing high compression processing when performing a PDF conversion, and the button 1006 instructing encryption when performing a PDF conversion.

FIG. 11 depicts a view illustrating an example of a screen, displayed on the display unit of the console unit 220 of the MFP 101 according to the first embodiment, for when encryption is instructed in accordance with the button 1006.

This screen is displayed when the button 1006 (“encrypt”) is selected by a user. A column 1101 is an input field for authentication information (a password) necessary to open encrypted image data. In the screen of FIG. 11, the column 1101 is displayed in a blank state, and a user thus inputs a password in the column 1101.

In this way, when making a conversion to a PDF file, by selecting “encrypt”, it is possible to make it so that a user who does not know the password cannot view the transmitted image data. Consequently, it is possible to prevent a user who does not know the password from viewing the image data. Note that the password for encryption and settings such as the file format set in FIG. 10 or FIG. 11 are saved in the RAM 213.

Returning to FIG. 9A again, in step S904, when a user who has pressed one of the buttons 1001 through 1004 of FIG. 10 presses an OK button that is not shown graphically to select a transmission format, the processing proceeds to step S905.

In step S905, the CPU 211 accepts an instruction for whether or not to perform a setting for a job end notification. This instruction may be made from the screen of FIG. 5A, or may be made by a user performing a predetermined operation on the console unit 220. Here, when a setting for performing a job end notification is accepted, the processing proceeds to step S906, and job end notification is set. In addition, when a setting for performing the job end notification is not accepted in step S905, the processing proceeds to step S907. Note that the setting for the job end notification in step S906 is stored in the RAM 213 as a notification flag. In step S906, the CPU 211 displays the job end notification setting screen illustrated in FIG. 5B, and accepts input of the buttons 501-504 and 506 from a user via this setting screen. Because the list of destinations that is displayed is only electronic mail addresses when a user selects the button 503, a pop-up menu (not shown) for selecting a destination only displays “Suzuki”, “Tanaka”, and “Sato”. When a user selects one of the destinations, the email address for the selected destination is displayed in the column 505. In this way, setting for the job end notification completes by the job end notification setting screen illustrated by FIG. 5B, and when a user presses an OK button (not shown) of the screen, the details that are set are saved to the RAM 213, and the processing proceeds to step S907.

In step S907, the CPU 211 waits for a transmission instruction from a user. In a case where a user redoes a transmission setting without performing a transmission instruction, the processing returns to step S902, but when there is the transmission instruction from a user, the processing proceeds to step S908.

In step S908, the CPU 211 executes transmission of the image data in accordance with the settings of step S902 through step S907. Note that, here, in a case of transmitting image data generated by the scanner 222 reading an original, transmission processing is performed in step S908 upon reading of the original by the scanner 222. The processing proceeds to step S909, and the CPU 211 confirms a result of the transmission of the image data that was performed in step S908, and if the transmission succeeded, the processing proceeds to step S911, and if the transmission failed, the processing proceeds to step S910. In step S910, the CPU 211 refers to the RAM 213 to determine whether or not “notify only at a time of error” was set by the button 502 in the job end notification setting (FIG. 5B). Here, if “notify only at a time of error” is set, the processing proceeds to step S912, and if not, the processing proceeds to step S911. In step S911, the CPU 211 refers to the RAM 213 to determine whether or not “always notify” was set in the job end notification setting. If “always notify” is set, the processing proceeds to step S912, and if not, the processing ends because there is no need to perform a job end notification.

In step S912, the CPU 211 refers to the RAM 213 to determine whether or not “transmit to oneself” was set in the job end notification setting. Here, if “transmit to oneself” is set, the processing proceeds to step S913, and if not, the processing proceeds to step S914. In step S913, the CPU 211 obtains the electronic mail address of the user who inputted the transmission job to set the notification destination, and the processing advances to step S916. Meanwhile, in step S914, the CPU 211 sets the notification destination to a destination set from the destination table by the user, and the processing proceeds to step S916.

In step S916, the CPU 211 refers to the RAM 213 to determine whether or not “attach original” was set in the job end notification setting. If “attach original” is set, the processing proceeds to step S917, otherwise the processing proceeds to step S919. In step S917, the CPU 211 determines whether or not “encrypt” was selected in the screen of FIG. 10. If it is determined that “encrypt” is not selected, the processing proceeds to step S918, otherwise the processing proceeds to step S919. In step S918, the CPU 211 attaches the transmitted original to the job end notification, transmits it, and this processing ends. Meanwhile, in step S919, the CPU 211 transmits a job end notification without attaching the transmitted original, and this processing ends.

In this way, by virtue of the first embodiment, even in a case where setting is made to attach a transmitted original to a job end notification, transmission is performed without attaching image data of the transmitted original to the job end notification in a case where a setting is made to encrypt and transmit the image data of the original. Consequently, it is possible to prevent the occurrence of a situation such as where an original is mistakenly transmitted to a person whose viewing of confidential information is not desired.

### Second Embodiment

Next, explanation is given regarding a second embodiment of the present invention. In the second embodiment, when displaying the job end notification setting screen (FIG. 5B), in a case where “encrypt” is already set by a file format setting, the button 506 for instructing “attach original” is set so that it cannot be pressed. In addition, in a case where “attach original” is already set by a job end notification setting, the button 1006 for instructing “encrypt” on the screen of FIG. 10 is set so that it cannot be pressed. Note that, because a hardware configuration or a system configuration of the MFP 101 according to the second embodiment are the same of the first embodiment previously described, description thereof is omitted.

FIG. 12 is a flowchart for describing processing for when the MFP 101 according to the second embodiment displays a setting screen for a job end notification. Note that the processing illustrated in this flowchart is achieved by the CPU 211 executing a program that has been deployed to the RAM 213. Note that description is given here by an example of displaying the job end notification setting screen illustrated by FIG. 5B which was described in the first embodiment.

Firstly, in step S1201, the CPU 211 waits for an instruction from a user for setting a job end notification. This instruction may be made from the screen of FIG. 5A which is described above, or may be made by a user performing a predetermined operation on the console unit 220. Upon receiving an instruction from a user to perform the job end notification in step S1201, the processing proceeds to step S1202. In step S1202, the CPU 211 determines whether or not the file format of image data to be transmitted has been set, and if set, the processing proceeds to step S1203, and otherwise the processing proceeds to step S1205.

In step S1203, the CPU 211 determines whether or not the file format is “PDF” and “encrypt” is set by the button 1006. If it is determined that “encrypt” is set, the processing proceeds to step S1204, otherwise the processing proceeds to step S1205. In step S1204, because “encrypt” is set for the file format, the CPU 211 displays, in the job end notification setting screen illustrated in FIG. 5B, the button 506 as hatched or grayed out so that “attach original” cannot be selected on the screen, and this processing ends. Meanwhile, in step S1205, the CPU 211 displays the job end notification setting screen illustrated by FIG. 5B without hatching or graying out the button 506, and this processing ends.

Consequently, in a case where “encrypt” is set by the setting of a file format, it is possible to set so that a setting for attaching a transmission original to the job end notification cannot be made. Consequently, it is possible to prevent the occurrence of a situation such as where an original is mistakenly transmitted to a person whose viewing of confidential information is not desired.

FIG. 13 is a flowchart for describing processing for when the MFP 101 according to the second embodiment displays a setting screen for a file format. Note that the processing illustrated in this flowchart is achieved by the CPU 211 executing a program that has been deployed to the RAM 213. Note that description is given here by an example of displaying the file format setting screen illustrated by FIG. 10 which was described in the first embodiment.

Firstly, in step S1301, the CPU 211 waits for an instruction from a user for setting a file format. This instruction may be made from a screen (not shown) displayed by a transmission application for transmitting image data, or by a user performing a predetermined operation on the console unit 220. When a file format setting instruction is inputted from a user, the processing proceeds to step S1302. In step S1302, the CPU 211 determines whether or not the job end notification is set with reference to the notification flag of the RAM 213 that is described above. Upon determining that the job end notification is set, the processing proceeds to step S1303, otherwise the processing proceeds to step S1305. In step S1303, the CPU 211 refers to the RAM 213 to determine whether or not “attach original” was set in accordance with the button 506 in the job end notification setting. Upon determining that “attach original” is set, the processing proceeds to step S1304, otherwise the processing proceeds to step S1305. In step S1304, the CPU 211 displays the button 1006 for instructing “encrypt” as hatched or grayed out on the screen of FIG. 10 so that it is not possible to make an instruction for “encrypt”, and this processing ends. Meanwhile, in step S1305, the CPU 211 displays the button 1006 of FIG. 10 as normal, enabling setting of “encrypt”, and this processing ends.

Consequently, when “attach original” is set in the setting of the job end notification, it is possible to prohibit encryption of an image data file. Consequently, it is possible to prevent the occurrence of a situation such as where an original is mistakenly transmitted to a person whose viewing of confidential information is not desired.

In addition, as another embodiment, in a case where the transmission destination of image data that is transmitted and the transmission destination of a job end notification are the same, if “attach original” is set in the setting of the job end notification, the transmitted image data may be attached even if the image data is encrypted and transmitted.

In addition, in a case where the transmission destination of the job end notification is a destination for an administrator, if “attach original” is set in the job end notification settings, the transmitted image data may be attached even if the image data is encrypted and transmitted.

### Other Embodiments

Embodiments of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-135659, filed Jul. 11, 2017, which is hereby incorporated by reference herein in its entirety.

What is claimed is:

1. An image processing apparatus capable of executing a transmission job for transmitting image data to a transmission destination, the apparatus comprising:
a scanner that reads a document and generates image data;
a memory storing instructions; and
at least one processor that executes the instructions to cause the image processing apparatus to:
accept a setting for notifying an end of the transmission job;
convert the image data generated by the scanner to image data of a first format without encrypting;
execute a first transmission job for transmitting the image data of the first format;
make a notification, in accordance with the setting, of the image data of the first format and an end of the first transmission job to a predetermined transmission destination;
convert the image data generated by the scanner to image data of a second format by encrypting;
execute a second transmission job for transmitting the image data of the second format; and
make a notification, in accordance with the setting, of an end of the second transmission job to the predetermined transmission destination,
wherein the image data of the second format is not included in the notification of the end of the second transmission job.

2. The image processing apparatus according to claim 1, wherein the setting includes a setting for whether the notification is to always notify when the transmission job ends or to notify in a case where the transmission job had an error termination.

3. The image processing apparatus according to claim 1, wherein the setting includes a setting of the predetermined transmission destination, and
one of a selection from an address book or a destination of a user can be set as the predetermined transmission destination.

4. The image processing apparatus according to claim 1, wherein the setting also includes a setting for whether or not to attach the image data transmitted in the transmission job to the notification.

5. The image processing apparatus according to claim 4, wherein the instructions further cause the image processing apparatus to prohibit a setting for attaching the image data transmitted in the transmission job to the notification in a case of transmitting the image data of the second format in the transmission job.

6. The image processing apparatus according to claim 4, wherein the instructions further cause the image processing apparatus to prohibit a transmission job for transmitting the image data of the second format in a case where a setting for attaching the image data transmitted to the transmission job to the notification is made.

7. The image processing apparatus according to claim 1, wherein it is possible to select, as the setting of the transmission job, a file format from JPEG, TIFF, XPS, and PDF, and encryption of the image data as the second format can be performed if PDF is designated.

8. The image processing apparatus according to claim 1, wherein, if the transmission destination of the second transmission job and the predetermined transmission destination are the same, the image data of the second format and the end of the second transmission job are notified to the predetermined transmission destination in accordance with the setting.

9. A method of controlling an image processing apparatus capable of executing a transmission job for transmitting image data to a transmission destination, the method comprising:
accepting a setting for notifying an end of the transmission job;
converting the image data generated by a scanner of the image processing apparatus to image data of a first format without encrypting;
executing a first transmission job for transmitting the image data of the first format;
making a notification, in accordance with the setting, of the image data of the first format and an end of the first transmission job to a predetermined transmission destination;
converting the image data generated by the scanner to image data of a second format by encrypting;
executing a second transmission job for transmitting the image data of the second format; and
making a notification, in accordance with the setting, of an end of the second transmission job to the predetermined transmission destination, wherein the notification of the end of the second transmission job does not include the image data of the second format.

10. A non-transitory computer readable storage medium on which is stored a computer program for making a computer execute a control method for an image processing apparatus capable of executing a transmission job for transmitting image data to a transmission destination, the method comprising:
accepting a setting for notifying an end of the transmission job;
converting the image data generated by a scanner of the image processing apparatus to image data of a first format without encrypting;
executing a first transmission job for transmitting the image data of the first format;
making a notification, in accordance with the setting, of the image data of the first format and an end of the first transmission job to a predetermined transmission destination;
converting the image data generated by the scanner to image data of a second format by encrypting;
executing a second transmission job for transmitting the image data of the second format; and
making a notification, in accordance with the setting, of an end of the second transmission job to the predetermined transmission destination, wherein the notification of the end of the second transmission job does not include the image data of the second format.
